(19) United States
(12) Patent Application Publication
(10) Pub. No.: US 2008/0193118 A1
(43) Pub. Date: Aug. 14, 2008

(54) DEVICE FOR ACCURATELY CAPTURING FACE IMAGE WITHIN CAMERA'S FIELD OF VIEW

(75) Inventor: Kun-Hak LEE, Suwon-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 12/029,785

(22) Filed: Feb. 12, 2008

(30) Foreign Application Priority Data
Feb. 12, 2007 (KR) 14349/2007

(51) Int. Cl. G03B 15/03

(52) U.S. Cl. 396/155

(57) ABSTRACT

Disclosed is a face image capturing device for guiding users to put their faces within a camera's field-of-view even at a relatively long distance from the camera and thereby capturing face images accurately. The device includes a light emitting device for emitting a light beam to enhance a field-of-view of the camera; a light guide path in close proximity to the camera; and guiding the light beam emitted from the light emitting device. Due to the light emitted straight forward from the end portion of the light guide path, users can first confirm the field-of-view of the camera even at a relatively long distance from the camera and then position their faces within the camera's field-of-view.

### PRIORITY

This application claims priority under 35 U.S.C. §119(a) of a Korean Patent Application entitled “Device for Accurately Capturing Face Image within Camera's Field of View” filed in the Korean Industrial Property Office on Feb. 12, 2007 and assigned Serial No. 2007-0014349, the contents of which are incorporated herein by reference.

### BACKGROUND OF THE INVENTION

1. Field of the Invention

The present invention relates to a device for shooting a face image, and in particular, to a device for accurately capturing an image of a face within a camera's field-of-view.

2. Description of the Related Art

Visual sensors for face detection are now used in a wide range of applications, such as, for example, in surveillance cameras. These sensors combine the functions of a camera and a computer to perform the same way as a human eye performs.

Both face detection and recognition are difficult to perform in environments with high variance, such as the varying size, position, and orientation of the facial image itself, as well as the varying lighting conditions under which the facial image is being captured. In other words, face detection and recognition are influenced by a variety of factors, such as by variations in the face orientation angle which changes in response to a change in camera angle, variations in facial poses (e.g., front on, tilted up or down by 45°, or turned to the left or right), variations in facial expressions of a face being captured and variations in lighting conditions under which the facial detection and recognition is performed.

FIG. 1 illustrates a conventional short-distance face recognition system. The short-distance face recognition system, which is generally embedded in a terminal, includes a convex mirror 10 or 20 mounted near a camera lens. When a person looks at his or her face in the convex mirror 10 or 20, the nearby camera captures an image of the face in a similar range.

The face recognition system using a convex mirror 10 or 20 has high-accuracy face recognition and image capture capabilities when a user looks into the convex mirror 10 or 20 at a short distance. However, the longer the distance between the user and the convex mirror 10 or 20, the more difficult it becomes to focus the face and capture a clear face image. In other words, users cannot predict how their face images are captured at a distance where they cannot see their faces in the convex mirror 10 or 20. Currently, face recognition and image tracking systems have been integrated into robots. Such robots should generally be kept a certain distance from their users. Robots that are positioned lower than their users may have to have their cameras adjusted in order to be directed to and in-line with the faces of the users. However, the robots offer no means for making up right or standing users accurately put their frontal faces within a field-of-view covered by the camera. In this case, users merely guess the field-of-view as they look at the camera.

Robots capable of autonomously tracking a human face and moving toward or turning a camera toward the face have recently been introduced. However, the face tracking and recognition algorithms used in such robots greatly increases the number of calculations needed to locate the face that falls within the camera's field-of-view. Moreover, numerous high-tech parts are required to implement the automatic face tracking and recognition, which results in the great increase of costs.

As such, conventional face recognition systems have drawbacks, such as excessive battery consumption, which limits usage time and is due to the numerous calculations performed by the internal processor units of these systems. Also, these conventional face recognition systems are seldom sufficiently integrated enough to include every part necessary for convenient face recognition. Furthermore, in order to utilize face recognition technologies in a variety of applications or devices, such as on mobile terminals, these systems must be developed at a low cost. Also, an effective solution is needed in order to allow users put their faces within a camera's field of view even when they are substantially positioned away from the camera itself.

### SUMMARY OF THE INVENTION

An aspect of the present invention is to substantially solve at least the above problems and/or disadvantage and to provide at least the advantages below. Accordingly, one aspect of the present invention is to provide a device for guiding users to put their faces within a camera's field-of-view and thereby accurately capturing facial images.

Another aspect of the present invention is to provide a device for guiding users to position their faces within a camera's field of view even at a relatively long distance so as to allow for accurate capturing of their face images.

According to another aspect of the present invention, there is provided a device for accurately capturing a face image in a mobile terminal. The device includes a camera lens module for taking an image of a user; a light emitting device provided adjacent to the camera lens module to emit light; and a light guide path provided above the light emitting device to guide the light received from the light emitting device to proceed straight forward.

### BRIEF DESCRIPTION OF THE DRAWINGS

The above and other aspects, features and advantages of the present invention will be more apparent from the following detailed description taken in conjunction with the accompanying drawings, in which:

FIG. 1 is a view illustrating a conventional short-distance face recognition system;

FIG. 2 is a view illustrating a face image capturing device according to a preferred embodiment of the present invention;

FIG. 3 is a detail view illustrating a module for confirming a camera's field of view according to a preferred embodiment of the present invention; and

FIG. 4 is a view illustrating the emission of light through a light guide path according to a preferred embodiment of the present invention.

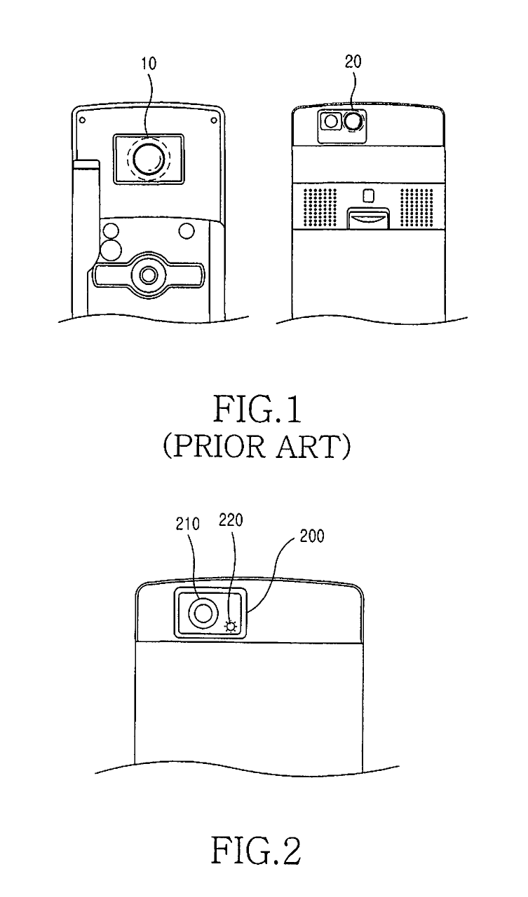

### DETAILED DESCRIPTION OF THE PREFERRED EMBODIMENTS

Hereinafter, preferred embodiments of the present invention will be described with reference to the accompanying drawings. In the following description, the same elements will be designated by the same reference numerals although they are shown in different drawings. Further, in the following description of the present invention, a detailed description of known functions and configurations incorporated herein will be omitted when it may make the subject matter of the present invention rather unclear.

The present invention provides a face image capturing device for guiding users to put their faces within a camera's field-of-view even at a relatively long distance from the camera and thereby capturing face images accurately. The device includes a light emitting device for emitting a light beam to illuminate a field of view of the camera and a light guide path provided as close as possible to the camera and guiding the light beam emitted from the light emitting device. Due to the light emitted straight forward from the end portion of the light guide path, users can confirm the field of view of the camera even at a relatively long distance away from the camera and can properly position their faces to fall within the field-of-view. Thus, the face image capturing device can capture accurate face images, without using complicated algorithms.

FIG. 2 is a view illustrating a face image capturing device according to a preferred embodiment of the present invention. In FIG. 2, a camera lens module and a light guide unit mounted in a mobile terminal will be explained in detail.

As illustrated in FIG. 2, a face image capturing device has a field-of-view confirming module 200, which includes a camera lens module 210 and a light guide unit 220 positioned adjacent to each other. The light guide unit 220 emits light to illuminate a field-of-view of the camera so that users can put their faces exactly within the field-of-view. The light guide unit 220 is provided as close as possible to the camera lens module 210 in order to capture a more accurate face image when the light emitted from the light guide unit 220 reaches the front face of a user.

In a conventional face recognition system using a convex mirror, users have to look into the convex mirror to position their faces within a camera's field-of-view. Here, users typically have difficulties in appropriately placing or directing their faces to fall within the camera's field-of-view when they are positioned at a relatively long distance away from the camera itself since users cannot see their faces in the convex mirror. According to a preferred embodiment of the present invention, the users can easily confirm whether their faces are placed exactly within the field-of-view of the camera due to the light emitted from the light guide unit 220.

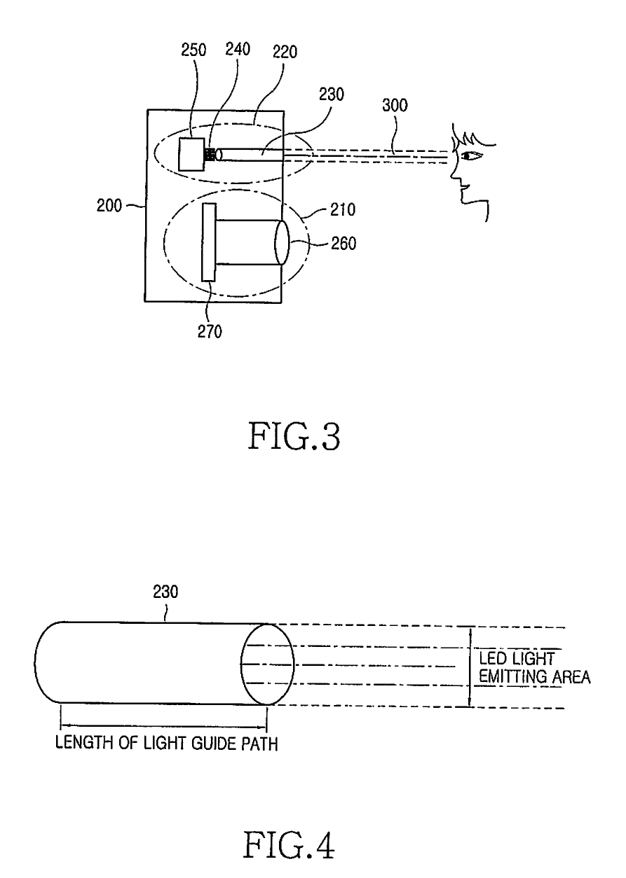

FIG. 3 is a detail view illustrating a field-of-view confirming module according to the present invention.

As illustrated in FIG. 3, the light guide unit 220 of the field-of-view confirming module 200 includes a light emitting device 240, a light emitting control unit 250 for controlling the light emitting device 240, and a light guide path 230 for guiding the light emitted from the light emitting device 240. The camera lens module 210, which captures user images includes a camera lens 260 and a camera module 270 for actually performing a camera function.

Hereinafter, the structure of the light guide unit 220 will be explained in more detail. The light emitting device 240 is a light source, such as an LED. If an LED having higher brightness is used, users can see the light from the LED at a longer distance. The light guide path 230 displaced near the light emitting device 240 is a transparent glass tube for guiding the light emitted from the light emitting device 240 to proceed straight forward. More specifically, the light incident on to the light guide path 230 from the light emitting device 240 is guided to a point parallel to the exposed end of the camera lens 260 along the light guide path 230 and proceeds further from the point in a straight forward direction. In operation, the light emitting control unit 250 is activates the light emitting device 240 only when demanded by the user for face recognition. In other words, the light emitting control unit 250 turns on or off the light emitting device 240 in response to the user's key input for turning on or off the light emitting device 240.

The light guided along the light guide path 230 proceeds straight forward. When the user's face is aligned with the optical axis 300 of the light from the light guide path 230, the user sees the light directly. In other words, when the user directly faces the light emitting direction, his or her face is exactly within the camera's field-of-view.

FIG. 3 shows that the user's face is aligned with the optical axis 300 of the light emitted from the light guide path 230. In such an alignment, the user can directly face the light, which means that the user's face is exactly within the camera's field-of-view, and that an accurate face image can be captured. However, when the user's face deviates from the optical axis 300, the user does not face the light emitting direction, indicating that the user has to move to position his or her face in the light emitting direction. Hence, in cases where the emitted light is focused on the user's face, an accurate face image can be captured.

Moreover, since the camera lens 260 and the light guide path 230 are disposed adjacent to each other, the user's face can be within the camera's field-of-view when the user's face is aligned with the optical axis 300 of the light emitted through the light guide path 230.

As explained above, the present invention provides a method and a device for guiding users to look into the camera so as to accurately capture the user's facial image, without using any separate face recognition apparatus. In particular, the face image capturing device according to the present invention enhances the camera's field-of-view using the directivity of light, which enables users to exactly face the camera even at a long distance. The directivity of emitted light is described below with respect to FIG. 4.

FIG. 4 is a view illustrating the emission of light through a light guide path according to a preferred embodiment of the present invention.

In FIG. 4, the light guide path 230 is formed in a straw shape. The central axis of the light guide path 230 is parallel to that of the camera lens module 210. The light guide path 230 has one end contacting the top surface of the light emitting device 240 and the other end is exposed outside. In other words, the light guide path 230 has the other end at the outer wall of the terminal.

The light guide path 230 has a straw-like shape with a hollow circular cross-section. The LED light proceeds straight forward through the straw-like light guide path 230. When the user looks into the light emitting portion, i.e. the exposed end of the light guide path 230 adjacent to the camera lens 260, the user's face is in a position where an accurate face image can be obtained. Since the light guide path 230 is in close proximity to the camera lens 260, the user's face can be substantially captured at the center of an image captured by the camera lens.

In addition, FIG. 4 illustrates the emission of light through the light guide path 230. Here, the longer the light guide path 230, the less the amount of light dispersed at the end of the light guide path 230, which improves the directivity of light from he light guide path 230. The distance that the light emitted from the light emitting device 240 could proceed varies according to the type of Light Emitting Diode (LED) and the length of the light guide path 230. In other words, the maximum distance at which users can see the light and recognize the location of the camera lens is determined according to the type of LED used and the length of the light guide path 230.

As explained above, the face image capturing device according to the present invention enables users to recognize the camera's field-of-view even at a relatively long distance from the camera and to position their faces within the camera's field-of-view so that an accurate facial image can be captured. Due to the light emitted through the light guide path, it can now be recognized whether the camera lens is accurately focused onto a user's face.

The face image capturing device according to the present invention enhances the camera's field-of-view using the light emitted through the light guide path, which is adjacent to the camera lens. Accordingly, users can know which direction or position they should stand to accurately face the camera even at a long distance. Moreover, with the development of camera lenses, various zooming functions, and image algorithms, cameras have been developed to capture clear images even at a relatively long distance. Thus, it is expected that the device according to the present invention can be integrated into a wide range of applications in the future.

Since the face image capturing device according to the present invention uses the simple principle of light emitting directivity, the present invention can be utilized in a variety of applications, such as mobile terminals, for example.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A device for accurately capturing a face image in a terminal, the device comprising:
a camera lens module for capturing an image of a user;
a light emitting device proximate to the camera lens module for emitting light; and
a light guide path proximate to the light emitting device to guide the light received from the light emitting device to proceed straight forward.

2. The device of claim 1, further comprising a light emitting control unit in contact with the light emitting device to turn on or off the light emitting device according to the user's selection.

3. The device of claim 1, wherein the light emitting device is a Light Emitting Diode (LED).

4. The device of claim 1, wherein the light guide path is parallel to a central axis of the camera lens module, and has one end contacting the top surface of the light emitting device and the other end exposed to the outside.
